(19) United States
(12) Patent Application Publication
(10) Pub. No.: US 2024/0041013 A1
(43) Pub. Date: Feb. 8, 2024

(54) PHOSPHORESCENT FISH LURING DEVICE AND METHOD OF USE

(71) Applicant: Kevin Joseph McKenzie, Paynesville, MN (US)

(72) Inventor: Kevin Joseph McKenzie, Paynesville, MN (US)

(21) Appl. No.: 17/880,079

(22) Filed: Aug. 3, 2022

(51) Int. Cl. A01K 85/01; A01K 85/00

(52) U.S. Cl. CPC A01K 85/011; A01K 85/1853

(57) ABSTRACT

A phosphorescent fish luring device for use in spearfishing includes first and second spheres, which are mutually attached by a coupler so that they are pivotable relative to each other. One or both of a first portion of the first sphere's outer surface and a first section of the second sphere's exterior surface is phosphorescent. A first connector is attached to the first sphere and is used to attach the first sphere to a fishing line or to a leader that is attached to a fishing line. A lure is attached to the second sphere by a second connector. The lure, the first sphere, and the second sphere attract a fish so that a user is positioned to spear the fish. Alternatively, with a hook being attached to the lure, the user catch fish on the hook using a rod and reel.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to fish lures and more particularly pertains to a new fish lure for use in spearfishing. The present invention discloses a fish lure that is phosphorescent so as to entice fish within range of a spearfishing device that is operated by a user.

### Description of Related Art Including Information Disclosed Under 37 CFR 1.97 and 1.98

The prior art relates to fish lures, which may comprise luminescent or lighted bobber assemblies, lures molded from phosphorescent materials, lures comprising light emitting diodes, and lures to which light sticks are attachable. What is lacking in the prior art is a fish lure comprising first and second spheres, which are mutually attached and pivotable relative to each other. A portion of one or both of first and second spheres is phosphorescent. A lure is attached to the second sphere. The fish lure attracts a fish so that a user is positioned to spear the fish.

### BRIEF SUMMARY OF THE INVENTION

An embodiment of the disclosure meets the needs presented above by generally comprising a first sphere and a second sphere. One or both of a first portion of an outer surface of the first sphere and a first section of an exterior surface of the second sphere is phosphorescent. A coupler is attached to and extends between the first sphere and the second sphere so that the first sphere is pivotable relative to the second sphere. A first connector is attached to the first sphere and is configured to attach the first sphere to a fishing line or to a leader that is attached to a fishing line. A lure is attached to a second connector, which is attached to the second sphere. The lure, the first sphere, and the second sphere are configured to attract a fish so that a user is positioned to spear the fish. Alternatively, with a hook being attached to the lure, the user catches fish on the hook using a rod and reel.

In a different embodiment, at least one sphere is provided. A first portion of an outer surface of the at least one sphere is phosphorescent. A first connector is attached to the at least one sphere and is configured to be attached to a fishing line or to a leader that is attached to a fishing line. A lure is attached to a second connector, which is attached to the at least one sphere. The lure and the at least one sphere configured to attract a fish so that a user is positioned to spear the fish. Alternatively, with a hook being attached to the lure, the user catches fish on the hook using a rod and reel.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a phosphorescent fish luring device according to an embodiment of the disclosure.

FIG. 2 is a front view of an embodiment of the disclosure.

FIG. 3 is a side view of an embodiment of the disclosure.

FIG. 4 is an in-use view of an embodiment of the disclosure.

FIG. 5 is an in-use view of an embodiment of the disclosure.

FIG. 6 is a flow diagram for a method utilizing an embodiment of the disclosure.

### DETAILED DESCRIPTION OF THE INVENTION

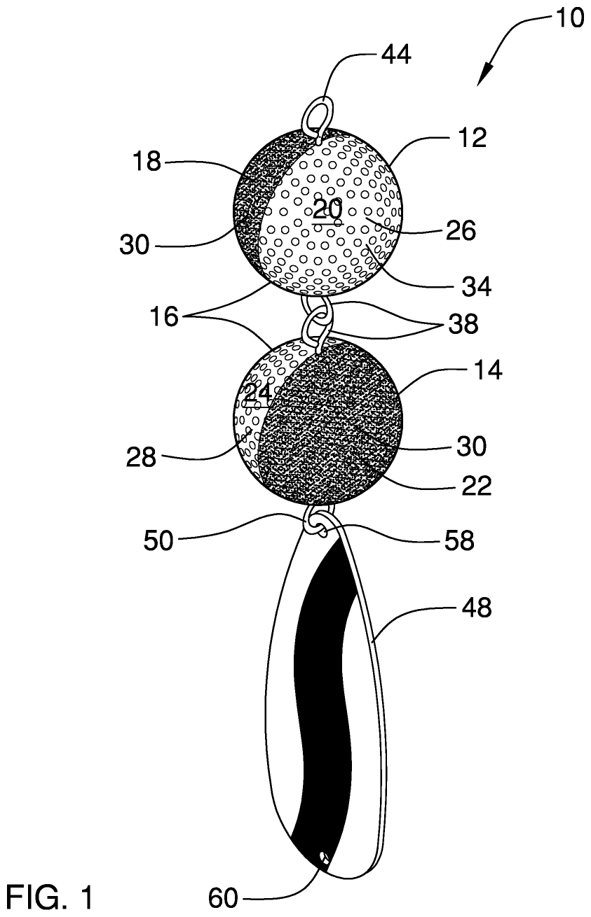

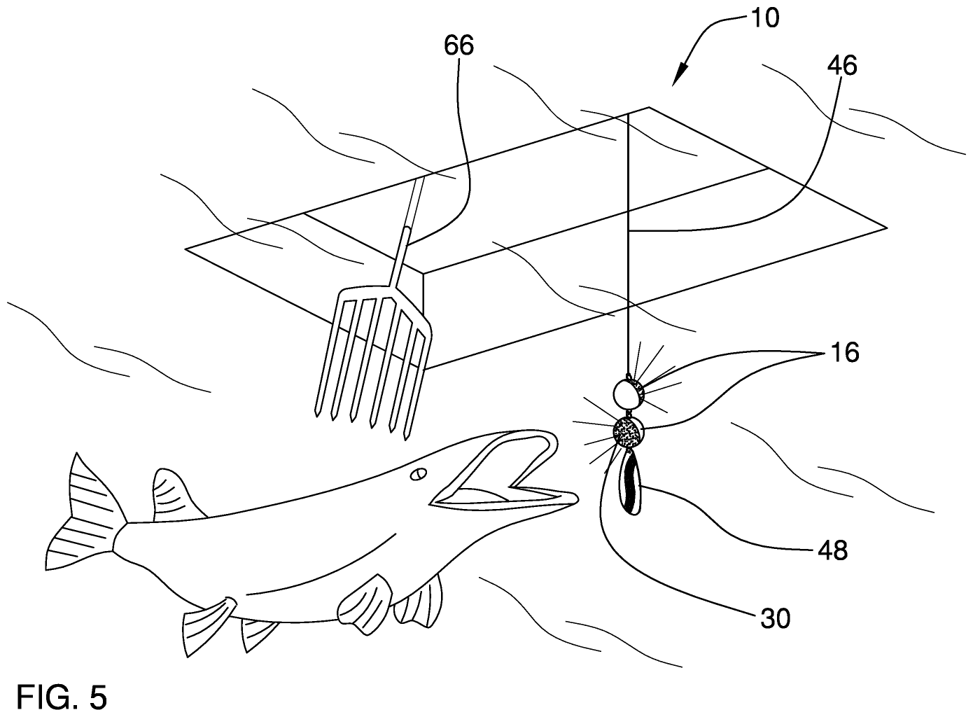

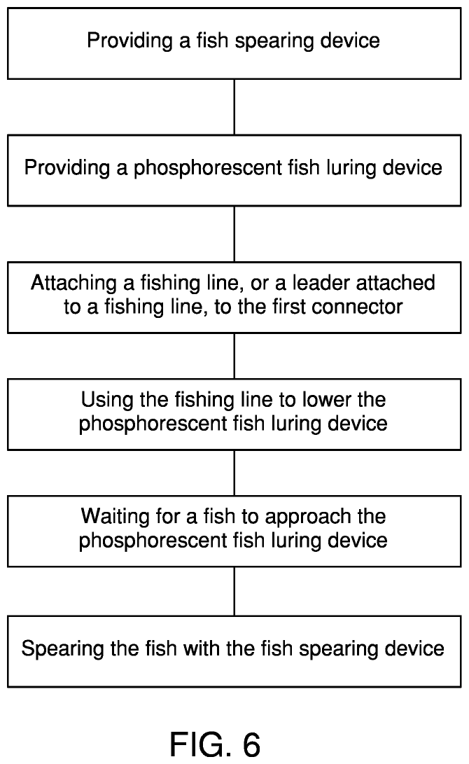

With reference now to the drawings, and in particular to FIGS. 1 through 6 thereof, a new fish lure embodying the principles and concepts of an embodiment of the disclosure and generally designated by the reference numeral 10 will be described.

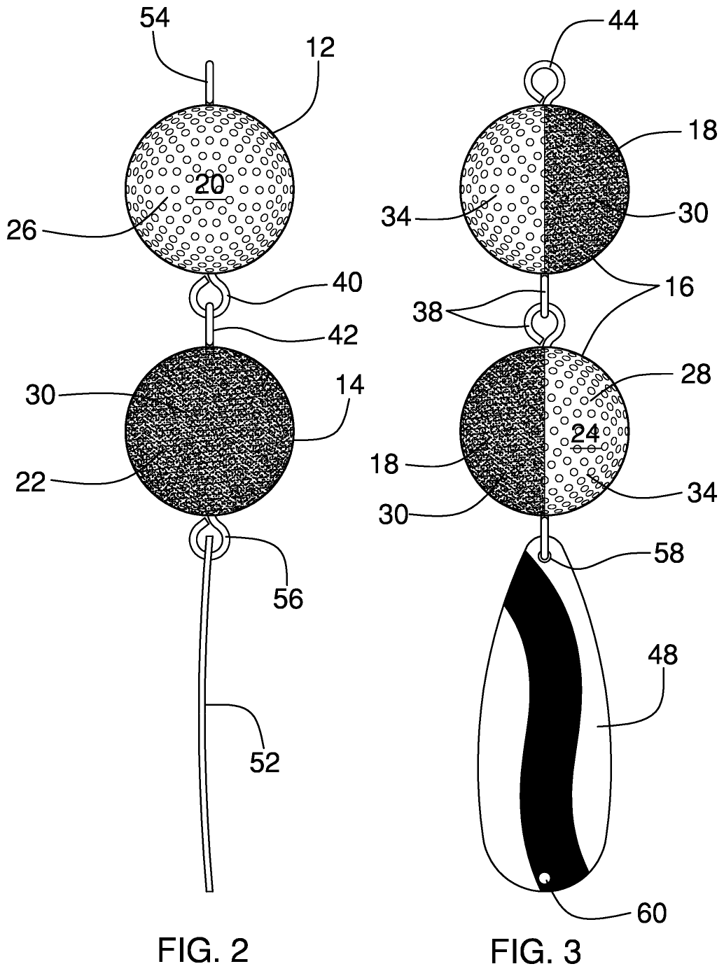

As best illustrated in FIGS. 1 through 6, the phosphorescent fish luring device generally comprises a first sphere 12 and a second sphere 14, which may comprise golf balls 16, as is shown in FIG. 1, or other type of ball of comparable size and mass, such as, but not limited to, rubber balls, aluminum balls, and the like. One or both of a first portion 18 of an outer surface 20 of the first sphere 12 and a first section 22 of an exterior surface 24 of the second sphere 14 is phosphorescent. As is shown in FIGS. 2 and 3, both the first portion 18 of the outer surface 20 of the first sphere 12 and the first section 22 of the exterior surface 24 of the second sphere 14 are phosphorescent and hemispherical, although the present invention also anticipates other configurations of the first portion 18 and the first section 22, such as, but not limited to, alternating stripe patterns, checkered patterns, and the like. The present invention anticipates a second portion 26 of the outer surface 20 of the first sphere 12 and a second section 28 of the exterior surface 24 of the second sphere 14 being white or otherwise reflective, such as by comprising reflective coating.

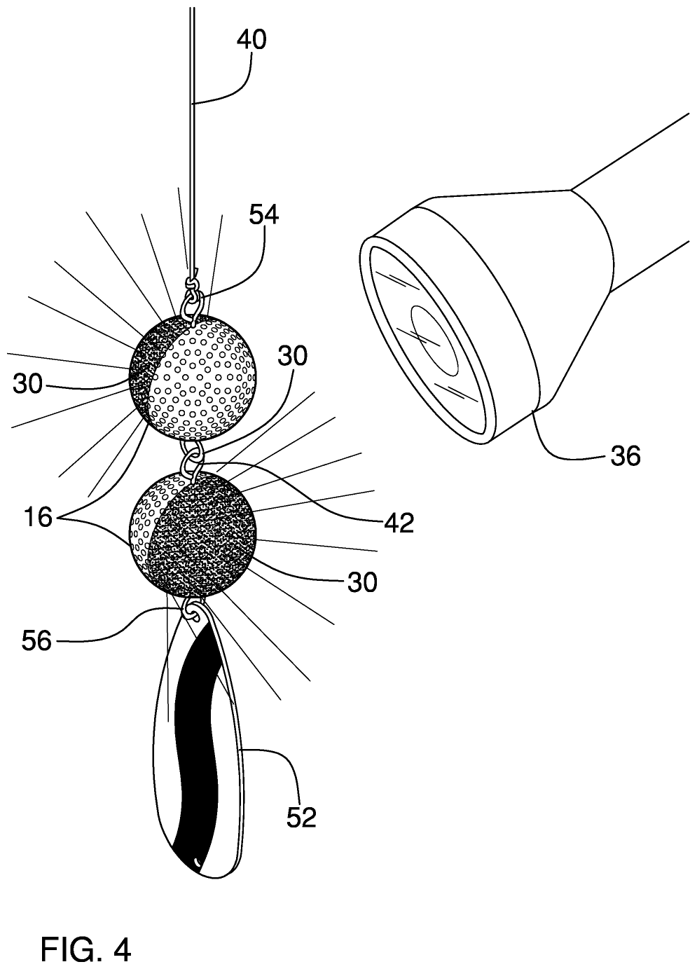

A phosphorescent coating 30 covers the one or both of the first portion 18 of the outer surface 20 of the first sphere 12 and the first section 22 of the exterior surface 24 of the second sphere 14. Such coatings are known to those skilled in the art of phosphorescent materials and may comprise a paint 32 with strontium aluminate and a dopant, such as europium, dysprosium, cerium, praseodymium, neodymium, or the like. The present invention also anticipates phosphorescent materials being incorporated into shells 34 of the golf balls 16. The phosphorescent coating 30 is activated upon exposure to light, such as from a flashlight 36, as is shown in FIG. 4 and which may be configured for emission of ultraviolet light, the sun, or other light source.

A coupler 38 is attached to and extends between the first sphere 12 and the second sphere 14 so that the first sphere 12 is pivotable, hingable, or otherwise movable relative to the second sphere 14. As is shown in FIGS. 2 and 3, the coupler 38 comprises a first ring 40 and a second ring 42, which are attached to the first sphere 12 and the second sphere 14, respectively. The first ring 40 and the second ring 42 are looped. The first ring 40 is perpendicular to the first portion 18 of the outer surface 20 of the first sphere 12, while the second ring 42 is parallel to the first section 22 of the exterior surface 24 of the second sphere 14. The first portion 18 and the first section 22 thus are biased in opposing directions, as is shown in FIG. 3. While other coupling means are anticipated for coupling the first sphere 12 to the second sphere 14, such as, but not limited to, ball and socket connectors, cables, cords, and the like, use of the first ring 40 and the second ring 42 in the orientation described above provides a flashing or strobing light effect that is visible from 360° around the phosphorescent fish luring device 10 as the first sphere 12 and the second sphere 14 rotate or oscillate relative to each other, thereby increasing a likelihood of luring a fish. The present invention also anticipates reversing the orientations of the first ring 40 and the second ring 42, which would achieve the same effect.

A first connector 44 is attached to the first sphere 12 and is configured to attach the first sphere 12 to a fishing line 46 or to a leader (not shown) that is attached to a fishing line 46. A lure 48 is attached to a second connector 50, which is attached to the second sphere 14. The lure 48 may comprise an ovate plate 52, as is shown in FIGS. 1-5, or other configuration, many of which are known to those skilled in the art of fishing lures. The first connector 44 and the second connector 50 may comprise a first eyelet 54 and a second eyelet 56, respectively, or other connecting means, such as, but not limited to, clips, rings, and the like. The second eyelet 56 is positioned through a first hole 58 in the ovate plate 52. The lure 48, the first sphere 12, and the second sphere 14 are configured to attract a fish so that a user is positioned to spear the fish. The present invention also anticipates use of a second hole 60 in the ovate plate 52 for attachment of a hook (not shown) for use of the phosphorescent fish luring device 10 in angling with a rod and reel.

The present invention is anticipated to be useful to users who enjoy spearfishing and angling, particularly at night. When used in spearfishing, light produced by the phosphorescent coating 30 not only serves to attract fish, but also to illuminate the fish when they approach the phosphorescent fish luring device 10, thus making the fish easier to see, identify, and spear. Thus, in another embodiment, the present invention may include at least one sphere which may including a single sphere, a pair of spheres, or up to three spheres each having a portion being coated with the phosphorescent coating 30.

The phosphorescent fish luring device 10 enables a spearfishing method 62, which comprises a first step 64 of providing a fish spearing device 66. A second step 68 of the spearfishing method 62 is providing a phosphorescent fish luring device 10 according to the specification above. A third step 70 of the spearfishing method 62 is attaching a fishing line 46, or a leader attached to a fishing line 46, to the first connector 44. A fourth step 72 of the spearfishing method 62 is using the fishing line 46 to lower the phosphorescent fish luring device 10 into water. A fifth step 74 of the spearfishing method 62 is waiting for a fish to approach the phosphorescent fish luring device 10. A sixth step 76 of the spearfishing method 62 is spearing the fish with the fish spearing device 66.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A phosphorescent fish luring device comprising:
a first sphere and a second sphere;
one or both of a first portion of an outer surface of the first sphere and a first section of an exterior surface of the second sphere being phosphorescent;
a coupler attached to and extending between the first sphere and the second sphere, such that the first sphere is pivotable relative to the second sphere;
a first connector attached to the first sphere and being configured for selective attachment to a fishing line or a leader, wherein the first connector is configured for attaching the first sphere to a fishing line or to a leader attached to a fishing line;
a second connector attached to the second sphere; and
a lure attached to the second connector, wherein the lure, the first sphere, and the second sphere are configured for attracting a fish, such that a user is positioned for spearing the fish.

2. The phosphorescent fish luring device of claim 1, wherein the first sphere and the second sphere comprise golf balls.

3. The phosphorescent fish luring device of claim 1, wherein both the first portion of the outer surface of the first sphere and the first section of the exterior surface of the second sphere are phosphorescent.

4. The phosphorescent fish luring device of claim 3, wherein the first portion of the outer surface of the first sphere and the first section of the exterior surface of the second sphere are hemispherical.

5. The phosphorescent fish luring device of claim 3, further including a second portion of the outer surface of the first sphere and a second section of the exterior surface of the second sphere being white.

6. The phosphorescent fish luring device of claim 1, further including a phosphorescent coating covering the one or both of the first portion of the outer surface of the first sphere and the first section of the exterior surface of the second sphere.

7. The phosphorescent fish luring device of claim 4, wherein the coupler comprises a first ring and a second ring attached to the first sphere and the second sphere, respectively, the first ring and the second ring being looped.

8. The phosphorescent fish luring device of claim 7, wherein:
the first ring is perpendicular to the first portion of the outer surface of the first sphere; and
the second ring is parallel to the first section of the exterior surface of the second sphere, such that the first portion and the first section are biased in opposing directions.

9. The phosphorescent fish luring device of claim 1, wherein the first connector and the second connector comprise a first eyelet and a second eyelet, respectively.

10. The phosphorescent fish luring device of claim 9, wherein the lure comprises an ovate plate, the second eyelet being positioned through a first hole in the ovate plate.

11. A spearfishing method utilizing a phosphorescent fish luring device, the method comprising the steps of:
providing a fish spearing device;
providing a phosphorescent fish luring device comprising:
a first sphere and a second sphere,
one or both of a first portion of an outer surface of the first sphere and a first section of an exterior surface of the second sphere being phosphorescent,
a coupler attached to and extending between the first sphere and the second sphere, such that the first sphere is pivotable relative to the second sphere,
a first connector attached to the first sphere and being configured for selective attachment to a fishing line or a leader,
a second connector attached to the second sphere, and
a lure attached to the second connector, wherein the lure, the first sphere, and the second sphere are configured for attracting a fish;
attaching a fishing line, or a leader attached to a fishing line, to the first connector;
using the fishing line to lower the phosphorescent fish luring device into water;
waiting for a fish to approach the phosphorescent fish luring device; and
spearing the fish with the fish spearing device.

12. The spearfishing method of claim 11, wherein the first sphere and the second sphere comprise golf balls.

13. The spearfishing method of claim 11, wherein both the first portion of the outer surface of the first sphere and the first section of the exterior surface of the second sphere are phosphorescent.

14. The spearfishing method of claim 13, wherein the first portion of the outer surface of the first sphere and the first section of the exterior surface of the second sphere are hemispherical.

15. The spearfishing method of claim 13, further including a second portion of the outer surface of the first sphere and a second section of the exterior surface of the second sphere being white.

16. The spearfishing method of claim 11, further including a phosphorescent coating covering the one or both of the first portion of the outer surface of the first sphere and the first section of the exterior surface of the second sphere.

17. The spearfishing method of claim 14, wherein the coupler comprises a first ring and a second ring attached to the first sphere and the second sphere, respectively, the first ring and the second ring being looped.

18. The spearfishing method of claim 17, wherein:
the first ring is perpendicular to the first portion of the outer surface of the first sphere; and
the second ring is parallel to the first section of the exterior surface of the second sphere, such that the first portion and the first section are biased in opposing directions.

19. The spearfishing method of claim 11, wherein the first connector and the second connector comprise a first eyelet and a second eyelet, respectively.

20. The spearfishing method of claim 19, wherein the lure comprises an ovate plate, the second eyelet being positioned through a first hole in the ovate plate.
